(19) United States
(12) Patent Application Publication
(10) Pub. No.: US 2025/0014547 A1
(43) Pub. Date: Jan. 9, 2025

(54) METHOD AND SYSTEM FOR AI-BASED AUTOMATIC AUDIO LOOP EXTRACTION AND GENERATION

(71) Applicant: BELLEVUE INVESTMENTS GMBH & CO. KGAA, BERLIN (DE)

(72) Inventors: DIETER REIN, BERLIN (DE); JURGEN JARON, BERLIN (DE)

(73) Assignee: BELLEVUE INVESTMENTS GMBH & CO. KGAA, BERLIN (DE)

(21) Appl. No.: 18/764,486

(22) Filed: Jul. 5, 2024

Related U.S. Application Data
(60) Provisional application No. 63/524,994, filed on Jul. 5, 2023.

(51) Int. Cl. G10H 1/00

(52) U.S. Cl. CPC G10H 1/0025; G10H 2210/111

(57) ABSTRACT

According to an embodiment, there is provided a system and method for automatic AI-based audio loop identification and extraction based on selections of song audio files from a user. It provides and benefits from a combination of analyzing the content of a song audio file database and implementing machine learning processes in an AI-based song audio file identification, extraction and therewith creation engine for the generation of audio loops from a selected song audio file.

This application claims the benefit of U.S. Provisional Patent Application Ser. No. 63/524,994 filed on Jul. 5, 2023, and incorporates said provisional application by reference into this document as if fully set out at this point.

### TECHNICAL FIELD

This disclosure relates generally to methods of generating audio content and, in more particular, to methods utilizing machine learning in an artificial intelligence-based (“AI”-based) selection engine for automatic audio content extraction and audio sample or audio loop generation from existing audio material.

### BACKGROUND

The ability to create a pleasing musical work has been a goal and dream of many people for as long as music has been around. However, a lack of knowledge of details regarding the intricacies of musical styles and music theory has prevented many from even attempting to write or create music. As such, this endeavor has, for a very long time, been the purview of individuals having the requisite knowledge and education.

With the advent of the personal computer and other computerized devices (e.g., tablet computers) and the widespread adoption of these devices in the home consumer market, software products have emerged that allow a user to create original music without needing to know music theory or needing to understand the terminology of music constructs such as measures, bars, harmonies, time signatures, key signatures, etc. These software products feature graphical user interfaces that provide users with a visual approach to song and music content creation that allowed the novice user easy access to the tools useful in music creation and enabled users to focus on the creative process without being hampered by having to learn the details associated with music theory.

In addition to increasing the accessibility of music generation, the content that is available and usable in the process of creating music has also been adapted to correspond to the directive of supplying an easy-to-use music generation approach. These sorts of programs typically utilize a database of individual sound clips of compatible length, e.g., audio samples, sound loops or just “loops”, which can be selected and inserted into the multiple tracks of an on-screen graphical user interface as part of the process of music creation. With these sorts of software products, the task of music or song creation has come within reach of an expanded audience of users, who happily take advantage of the more simplified approach to music or song creation as compared with note-by-note composition. These software products have evolved over the years, gotten more sophisticated and more specialized and some have even been implemented on mobile devices.

The general approach to music or song creation provided by these software products has remained virtually unchanged, even though the processing power of the computing devices has increased and the types of devices that run this software has expanded on par with the changes in device distribution. That is, the conventional approach to music creation which has remained largely unchanged involves requiring the user to select individual pre-generated audio loops that represent different instruments (e.g., drums, bass, guitar, synthesizer, vocals, etc.), and arrange these loops in digital tracks to create individual song parts, typically with a length of 4 or 8 measures, the goal being the creation of a full audio clip or song. Using this approach most users are able to create one or two song parts with the help of the graphical user interface of a mobile or desktop-based software product according to their own taste and are therefore potentially able to generate individual verses and maybe the refrain of their own song.

To assemble a large number of available and selectable audio loops for the user is a daunting undertaking. In many cases a large number of professionals in audio creation generate many high-quality loops for individual instruments, genres and all that content or individual loops are preferably created with the intent that the loops will only be utilized in a digital audio generation program.

Thus, what is needed is a system and method that allows the generation process of digital audio samples or audio loops to be automatized, wherein a machine learning AI-based is utilized for the automatic generation and provision of sections of audio content being it loops or samples from a selected provided audio file.

Heretofore, as is well known in the media editing industry, there has been a need for an invention to address and solve the above-described problems. Accordingly, it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with accompanying drawings, should not be construed as limiting the invention to the examples (or embodiment) shown and described. This is so because those skilled in the art to which the invention pertains will be able to devise other forms of this invention within the ambit of the appended claims.

### SUMMARY OF THE INVENTION

According to an embodiment, there is provided a system and method for hybrid AI-based audio content identification and extraction. In one embodiment an algorithm is provided that utilizes signal processing analysis, machine learning processes, deep learning processes, or audio analysis neural networks. These processes and networks are implemented preferably via an AI engine that is directed to identify and generate audio content in and from a database of provided and selected or curated song audio files.

It should be clear that an approach such as this would be a tremendous aid to the user and would additionally mean such would assist in the development and the creation of professional music pieces/songs. This approach delivers functionality and an opportunity for the user to utilize music generation programs which enable a user to begin, continue and complete the music creation process. Additionally, due to the fact that the identification, extraction, creation, provision and selection of available and potentially usable audio samples or loops is based on a combination of deep signal processing algorithms and machine learning information, the user is provided with a list containing generated audio samples or audio loops according to the selection of provided song audio files. Therefore, the previously fixed, limited and streamlined music generation process of a piece of music piece or song could benefit extraordinarily from such an approach that allows the user to control the generation process of audio content using a database of audio loops or audio samples generated dynamically from provided song audio files or music works.

The foregoing has outlined in broad terms some of the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention. Further objects, features and advantages of the present invention will be apparent upon examining the accompanying drawings and upon reading the following description of the preferred embodiments.

### BRIEF DESCRIPTION OF THE DRAWINGS

These and further aspects of the invention are described in detail in the following examples and accompanying drawings.

FIG. 1 is an illustration of a working environment of the instant invention according to an embodiment.

FIG. 2 depicts one embodiment of a workflow suitable for use with the instant invention that displays one aspect of its functionality.

FIG. 3 depicts an overview of the individual parts and processes of the instant invention.

FIG. 4 contains a schematic illustration of an example of a recurrence plot for the extracted audio features.

FIG. 5 discloses a more detailed workflow processing the input audio material according to an embodiment of the instant invention.

FIG. 6 discloses a workflow showing the steps utilized for generation of the instrument tracks from an input audio material according to an embodiment of the instant invention.

FIG. 7 illustrates two different variants of instrument track generation according to a preferred embodiment of the instant invention.

FIG. 8 discloses the process of audio material segmentation in an elaborate workflow according to a preferred embodiment of the instant invention.

FIG. 9 illustrates the steps utilized for chord estimation according to a preferred embodiment of the instant invention.

FIG. 10 contains an illustration of an example output of the hierarchical segmentation step 840 that is used to determine segment lengths.

### DETAILED DESCRIPTION

While this invention is susceptible of embodiment in many different forms, there is show in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

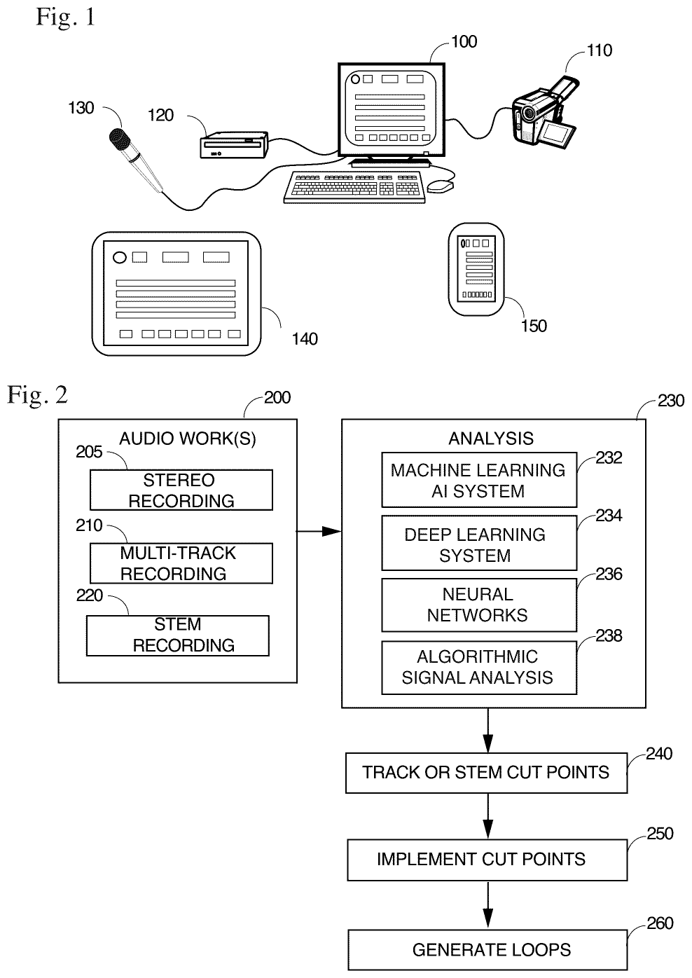

As is generally indicated in FIG. 1, at least a portion of the instant invention will be implemented in form of software running on a user's computer 100 or another device with a CPU such a table computer, smart phone, etc. For purposes of the instant disclosure, the word “computer” or CPU will be understood generally to refer to any programmable device such as those listed in the previous sentence. Such a computer will have some amount of program memory and storage (whether internal or accessible via a network) as is conventionally utilized by such units. Additionally, it is possible that an external video 110 or digital still (or video) camera of some sort be utilized with—and will preferably be connectible to—the computer so that video and/or graphic information can be transferred to and from the computer 100 (FIG. 1). Preferably the camera 110 will be a digital video camera, although that is not a requirement, as it is contemplated that the user might wish to utilize still images from a digital still camera in the creation of his or her multimedia work. Further given the modern trend toward incorporation of cameras into other electronic components (e.g. in handheld computers, smart phones, laptops, etc.) those of ordinary skill in the art will recognize that the camera might be integrated into the computer or some other electronic device and, thus, might not be a traditional single-purposes video or still camera. Although the camera will preferably be digital in nature, any sort of camera might be used, provided that the proper interfacing between it and the computer is utilized. Additionally, a microphone 130 might be utilized so that the user can add voice-over narration or vocals to a multimedia work and an external storage device 120 such as a CD or DVD burner, an external hard disk, a SSD drive, etc., could prove to be useful for storing in-progress or completed works. Further, it might also be possible, and is shown in FIG. 1, that the process of the instant invention might be implemented on portable tablet computer devices 140 or on mobile devices, such as smart phones 150.

Turning next to FIG. 2, this figure illustrates a high-level overview of one preferred embodiment of the instant invention. This system begins with the user's selection and provision of one or more audio works 200. The user's audio work will typically be in the form of a digital file that contains a stereo recording 205, a multi-instrument/multi-track composition 210 or a collection of separate instrument stem recordings 220.

As is well known to those of ordinary skill in the art, a stem is an element of a song or other audio work that can be isolated and exported as its own audio file. Each stem can be edited or rearranged separately from the others. For example, the stems might be a drum stem, a bass stem, a melody stem, and a vocal stem, although the number of stems and their contents would obviously depend on the nature of the audio work. A stem may be a mono- or stereo recording that is mixed from individual tracks of instruments. For example, a drum stem could be an audio file that has all of the drum tracks mixed together. As another example, the instrument tracks, vocal tracks, drum tracks and effect tracks that make up a musical work might be separately extracted from an audio work to yield a collection of stems for that musical work. A multitrack recording session might contain from 20 to a couple of hundred tracks, stem recording sessions usually will contain only 4 to 20 tracks.

Continuing again with FIG. 2, the song or other audio file provided by the user will be analyzed 230 using methods that include deep signal processing techniques derived from machine learning 232, deep learning 234 or pre-existing audio analysis neural networks 236 and algorithmic signal analysis 238. The system for machine-based learning 232, the deep learning 234 and the neural networks 236 are constantly being trained with an available database of audio song files in its complete form or already separated into audio loops, audio samples, or stems. The algorithmic signal analysis step provides initial estimates of the audio segments cut points for the provided audio works. These initial estimates are then refined via the analysis steps from the machine learning, deep learning system or neural network which results in s final determination of the track or stem cut points as is described in greater detail below.

As noted above one product of the analysis step 230 is a collection of track or stem cut points 240 for each selected audio file. In a next preferred step, the instant invention will apply the cut points 250 and separate the original audio file tracks or stems into multiple parts, the audio loops 260.

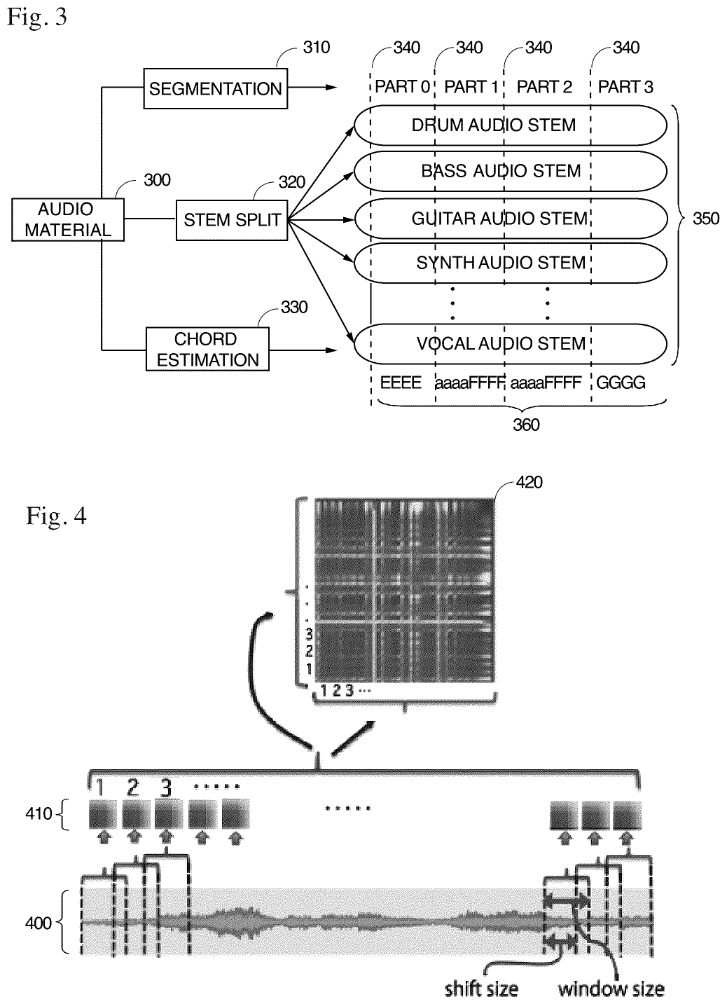

Turning next to FIG. 3, this figure depicts a high-level overview of the analysis step 230. Audio material 300 is provided by the user as input. Three different processes are applied to the user's audio material, with the stem splitting step 320 being an initial step. This step splits the provided original audio track into multiple audio tracks/stems 350, preferably one track per instrument or instrument group. These tracks are typically called stereo masters (“stems”) which mixed back together would form the original audio material. Note that the terms “stems” and “tracks” may be used interchangeably herein to describe audio units that are produced by the stem split step 320.

An additional preferred step is the chord estimation step 330 which provides chord estimates for every beat or measure in the audio work. In the example of chord sequences 360 of this figure, capital case letters represent major chords and lower case letters represent minor chords. Note that chord estimation 330 might be done before or after the segmentation step 310. In either case, the results of the chord estimation step 330 are matched with the results from the segmentation step 310 to determine the consistency of the chord sequences 360 across the proposed loop segments and possibly edit the loops accordingly. Consistency might be used in many ways, but as an example, if certain chord progressions are used repeatedly in a music work, some loops might be lengthened to capture the entire progression or shortened so that they only contain such a progression. In other cases, loops might be lengthened or shortened so that the final note is in the same key as the music item. Those of ordinary skill in the art will understand how the chord progression and frequency of changes might impact the segmentation points.

The segmentation step 310 is responsible for determining cut points for the loops 340 based on identifying musically relevant segments, with the segmentation points (or “cut points”) defining the end points/cut points of audio loops that will then be provided to the user for review and/or modification. This might be done in many ways but one preferred approach would be to use beat and tempo detection to start the process of determining the cut points, possibly constraining the cut points to fall at specific beat lengths, e.g., 4, 8, 12, beats for 4/4 time signature. The application of this step to other time signatures, e.g., 3/4, 5/4, 6/8, 12/8, 5/4, etc., should be clear. Although the example of this figure might indicate that the segmentation points will be uniformly spaced and the same length for each stem, and although that is the case most of the time, that is not a requirement. Subsequent hierarchical segmentation analysis can provide cut points that might be different for each stem. Additionally, the curated segmentation cut points for the audio works in the database could differ in length and/or be different for each stem which could result in an AI system that has been trained to analyze each stem separately. Finally, even when beat-based segmentation is employed the results might differ depending on the audio content of the analyzed stem. For example, a drum stem might provide different segmentation points than a guitar stem.

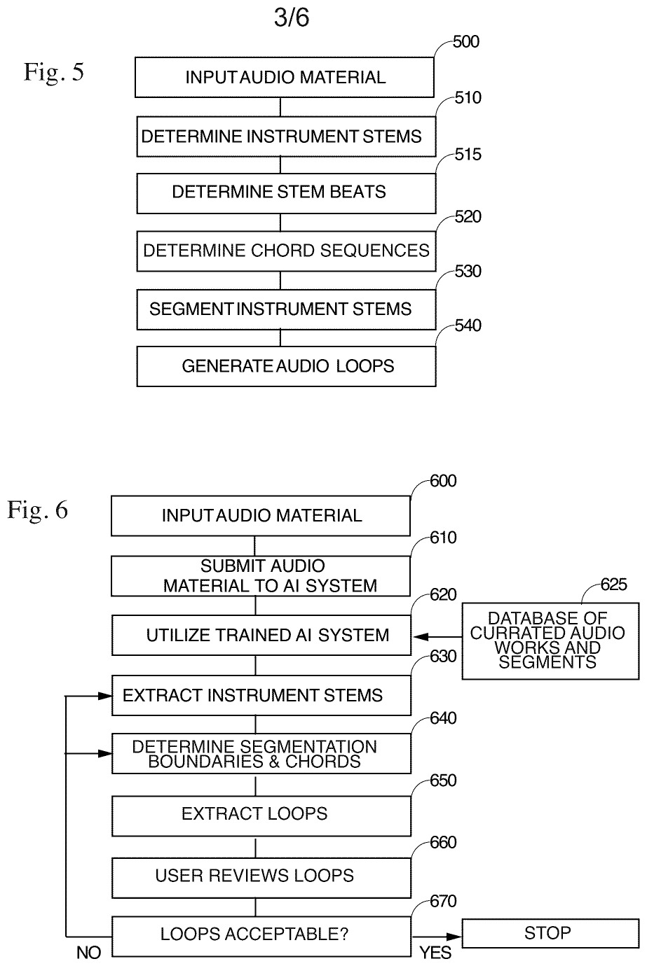

FIG. 5 contains a more detailed workflow of the processing steps implemented onto the input audio material according to an embodiment of the instant invention. The selected original audio material is provided to the system of the instant invention by the user 500, wherein in a first preferred step the original audio material is analyzed by the instant invention to separate the original audio into individual instrument tracks 510. The instrument tracks are further analyzed to determine boundary values that define potential audio loop borders which will be used to define the borders of the segments of the instrument tracks 520. In a next preferred step, the audio content in the segmented instrument tracks is analyzed to determine chord sequences 530, wherein the chord sequences are then matched with the determined boundary values that define the audio loop borders. The system will then generate audio loops 540 from that determined segments of instrument tracks for which the determined chord sequences are consistent.

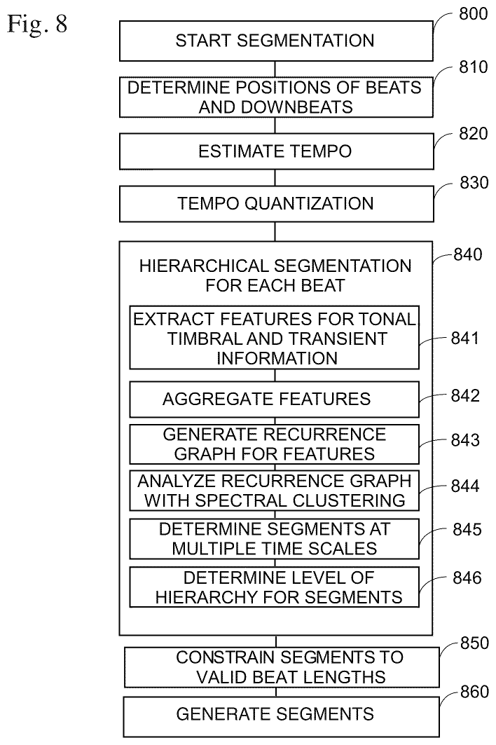

Coming next to FIG. 6, this figure contains one potential workflow showing in greater detail the steps utilized for generation of the instrument stems and loops from audio material provided by a user according to an embodiment. In a first preferred step, the user selects the original audio material 600 and provides it to the instant system. Next, the audio material is submitted to an AI system 610 that has been trained with a curated database 625 of audio material that contains both complete audio works as well as the stems of those works which have been separated into loops by experts. That is, the database consists of complete audio works plus the extracted and stored stems/tracks, together with data detailing the section boundaries.

As disclosed previously, the AI system will extract the stems 630, the system will then, in conjunction with signal analysis processes, determine the segment boundaries and another AI system will determine the chord sequence(s) of the provided audio work. The previous generated and determined information will be used to obtain prospective or candidate loops 650 which are presented to the user for review 660. If the user approves 670, the process will end and the one-or more approved loops will be stored so that the user can use them in another music project. Otherwise, the user will be able to ask that additional and/or alternative loops be generated. In some cases, the system will automatically return to step 640 and recalculate the segmentation boundaries, chords, etc., and present new loops to the user. In other instances, it might return to step 630 and just recalculate segmentation boundaries. In still other cases, the user might provide guidance as to how the next iteration of loop production should proceed, e.g., by specifying that more or fewer stems be created, more or fewer loops be extracted, etc. Those of ordinary skill in the art will recognize that there are any number of ways to shape the process of loop extraction.

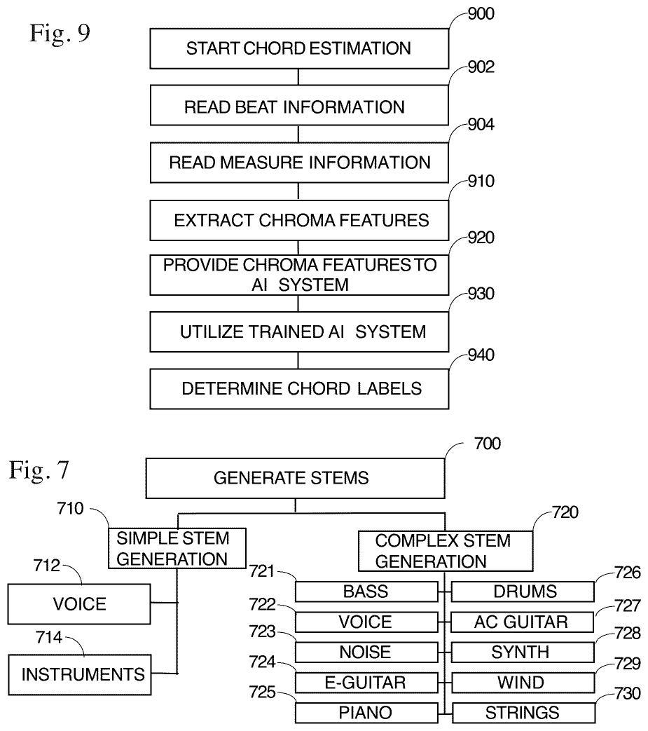

Turning next to FIG. 7, this figure illustrates two different user-selectable approaches to instrument stem generation according one embodiment, wherein the audio material provided by the user 700 is processed according to the user's desired degree of complexity. For example, the user might be provided with a choice between a simple stem generation 710 approach which will extract, say, a voice stem 712 separately from the remaining instruments in the audio 714. In cases where there are no vocals, the voice stem might be replaced by a melody stem which tracks the melody of the work no matter which instrument carries that component. Alternatively, in this embodiment the user will be able select a more complex track generation process 720, wherein if possible the audio material will be separated into ten stems, these being bass 721, voice 722, noise 723, e-guitar 724, piano 725, drums 726, AC guitar 727, synth 728, wind 729 and strings 730, which are then also further utilized in the loop generation process with each track potentially providing different audio loops. Of course, the number and type of stems selected will depend on the content of the music as well as the choice of the user or software designer.

Coming next to FIG. 8, this figure discloses in greater detail an embodiment of the audio material segmentation 800 process. It should be mentioned at the outset that this embodiment the segmentation process 800 is implemented automatically on the separate stems of the original audio material and proceeds through until segmentation is completed. As a first step, the instant invention will determine the downbeat (first beat in a measure) and the positions of the other beats in the audio material 810. The number of beats in a measure will then be used to estimate the tempo in beats per minute 820.

Next, a quantization step will preferably be performed on the estimated beat locations to quantize the tempo 830. This step applies time stretching to each detected beat position to conform the timing of the audio material to the catalogue of audio loops utilized by the instant invention. As a next preferred step, the instant invention will initiate the step of hierarchical segmentation 840 which involves a number of individual steps that are applied to each determined beat.

As a next preferred step the instant invention will extract features that encode tonal, timbral and transient information 841 at each beat. The timbral information would include the audio frequency identified and the tonal information would indicate at each beat whether the music was in a major and minor key, chromatic, whole tone, modal and atonal information about the audio at that specific beat. Transient information would identify the start of the melodic audio-which might be characterized as the highest peak of the amplitude or “attack” level. In some embodiments, this might be accomplished by computing and plotting a CQT, i.e., a Constant Q Transform.

The extracted features are then, in a next preferred step, aggregated for each beat 842 and numerical values representing these features will be collected. This aggregation has the effect of reducing the dimensionality of the CQT for subsequent calculation by making these features beat-synchronous. The aggregation might be performed by combining (e.g., median, sum, average, etc.) the CQT values across the duration of the beat. For example, if the beat is quarter notes and the quarter notes are based 0.5 second apart, the beat-synchronous value for the beat at 0.5 seconds would be the aggregation (e.g., the sum) of the CQT values between 0.5 and 1.0 second. This would result in a matrix of lower dimensions that has unique values only at the beat locations in the audio work.

In a next preferred step the aggregated features from the CQT will be plotted as a recurrence graph 843. The aggregated information from the CQT at each beat is a multivalued vector from which a recurrence graft will be calculated. FIG. 4 provides a simplified example of how such a plot might be calculated for a single time series. As can be seen, a number of fixed length windows are stepped along the length of the audio work 400. Each short window gives rise to a recurrence plot 410 The amount of shift applied to the window at each step is less than the width of the window so that successive windows overlap with each other. In some embodiments, the window length might be 4000 samples with a shift of 3000 samples so that the overlap is 1000 samples. This might be appropriate if the input audio work was an MP3 file which is sampled at 44.1 kHz. Then, the individual recurrence plots are compared with each other to produce the recurrence plot of recurrence plots 420. Note that a similar approach can be used for vector quantities of the sort that are obtained from the aggregated beats obtained from the CQT.

In some embodiments, the distance measurement that is used in the recurrence calculation is a k-nearest neighbor algorithm. If the entries of the recurrence matrix are rec [i,j], three possible measurements are available:

$$Connectivity : rec [ i , j ] = \{ \begin{matrix}1 , frames i and j are repetitions , \\ 0 , frames i and j are not repetitions\end{matrix}$$

$$Affinity : rec [ i , j ] > 0 Yields a measures of how similar frames i and j are . \\ This approach produces a ( sparse ) self - similarity matrix .$$

$$Affinity : rec [ i , j ] > 0 Yields a measure of measures how similar frames i and j are . \\ This approach produces a ( sparse ) self - distance matrix$$

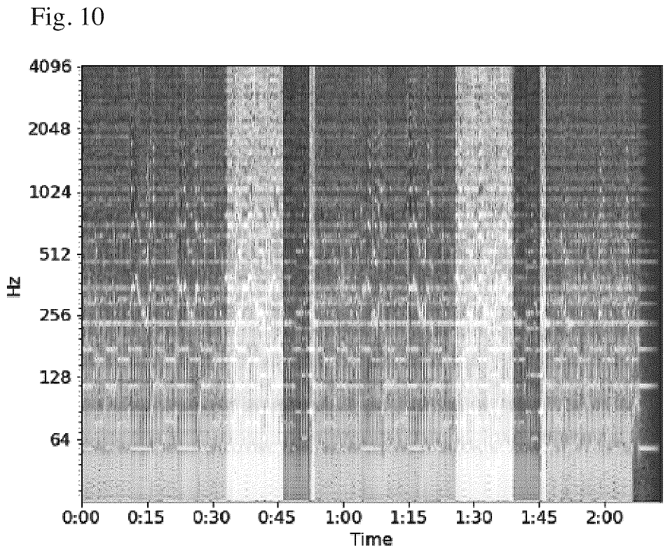

Returning to the description of FIG. 8, in a next preferred step the generated recurrence plot will be analyzed 844 after application of a Laplacian filter with spectral clustering using sets of normalized eigenvectors. That is, a Laplacian or similar 2D edge-detecting/enhancing filter will preferably be applied to the symmetric recurrence plot. Although the edge enhancing filter is very helpful at times, it is optional. Then one or more normalized eigenvectors of the Laplacian filtered normalized recurrence plot will be calculated and used in a spectral clustering algorithm. The eigenvectors will preferably be normalized to have unit length as is conventionally done. The clustering step can be performed with different numbers of eigenvectors, with a greater number of eigenvectors yielding different numbers of potential audio groups/segments. The number of eigenvectors used, which potentially will be a parameter that can be selected by the user, will define the audio segments at different time scales 845. FIG. 10 contains an example plot that indicates in a general way the how the segments might be identified after the beat vectors have been assigned to clusters. As noted below, the candidate sequence lengths that are determined by this step are then matched with the information from the chord segmentation steps that are disclosed in connection with FIG. 9 to further improve the quality of the segment cut points, by deleting those segments where the chord determination results show that the chords are not consistent and keeping the segments where the chord determination results are consistent.

In a next preferred step the instant invention will identify the level of hierarchy for the defined audio segments 846, hierarchy levels being beat, phrase or part listed in order of increasing length. This may also be thought of as characterizing the music form of the audio segments. That is, the level of the hierarchy refers to a “ranking” of the segments in order of length and organization. As another example the hierarchy levels might be motive/motif, phrase, form, part, and movement which are also arranged in increasing order. Of course, those of ordinary skill in the art might devise other hierarchical orderings which ultimately will depend on the way the loops are generated and the software is programmed.

The results from the previous steps are utilized by the instant invention to determine boundary points for candidate segments which will, in a next preferred step, be matched with beat length values 850 to construct segments of acceptable lengths for further utilization by the user. The valid beat lengths would include, depending on the time signature of the original audio work, 4, 8, 16 or 32 beats. It is preferable in most cases that the candidate audio segments that are presented to the user will at least rise to the level of a musical part or phrase, the latter of which is typically defined to be four measures long. If a candidate audio segment is not of the preferred length in some cases combinations with adjacent segments might be considered or the proposed segment might be rejected altogether, etc. Candidate loops that are too long would be considered for possible subdivision, if possible. Of course, this step is optional and, in some embodiments, the raw candidate segments might be presented to the user as-calculated.

As a last step the instant invention will extract and present to the user the segments 860 using the computational results from segmentation steps 840.

Turning next to FIG. 9, this figure illustrates some steps that might be utilized in connection with estimating the chords and chord patterns of the music item. As has been mentioned previously in connection to the segmentation process, the chord estimation process is not intended to be initiated by the user, this process is an essential part of the audio loop generation process of the instant invention, which begins after the user provides audio material.

As a first preferred step the system accesses the previously identified beat 902 and measure 904 determinations. In this embodiment that step will be followed by chroma feature extraction 910 at each of the individual beat locations and these extracted chroma features are then provided to a previously trained AI system 920 that has been trained to associate chroma features with music chords. This trained AI system will provide information 930 about potential chord labels 940 for the different sections and these chord estimation results are then matched with the information provided by the segment determination process to enhance the quality of the segment determination as has been described above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

If the specification or claims refer to “an addition” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiment, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a range having an upper limit or no upper limit, depending on the variable defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as is fully set out at this point.

### CONCLUSIONS

Of course, many modifications and extensions could be made to the instant invention by those of ordinary skill in the art. For example, in one preferred embodiment an experienced user might be provided with an elaborate graphical user interface allowing the user to define specific parameter regarding the identification and extraction of loops. So, for example a graphical user interface might be provided that allows the user to define the length of desired audio loops, or providing a specific value determining the number of audio loops that are to be extracted from a selected audio song file.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method generating one or more loops from a user supplied audio work, comprising the steps of:
(a) accessing a curated database containing a plurality of audio works, each of said audio works having a plurality of stems extracted therefrom and data defining segment boundaries within each of said plurality of stems;
(b) training an AI software program on said curated database, thereby obtaining a trained AI;
(c) accessing a music work provided by a user;
(d) using said trained AI to extract a plurality of stems from said user supplied audio work;
(e) using at least one of said plurality of stems to estimate beat locations of said audio work;
(f) using any of said estimated beat locations to select a plurality of segment cut points;
(g) generating said one or more loops from one or more of said plurality of stems using said plurality of cut points, thereby obtaining one or more generated loops; and
(h) performing at least one of said one or more generated loops for the user.

2. The method of generating one or more loops according to claim 1, wherein step (h) comprises the steps of:
(h1) selecting one of said plurality of stems;
(h2) calculating constant Q transform values for said selected stem;
(h3) aggregating said constant Q transform values at each of said beat locations;
(h4) generating a recurrence graph from said aggregated constant Q transform values;
(h5) determining a plurality of eigenvectors of said recurrence graph;
(h6) selecting a set of eigenvectors from said plurality of determined eigenvectors; and
(h7) using said set of eigenvectors to apply spectral clustering to said recurrence graph, thereby obtaining said plurality of segment cut points.

3. The method of generating one or more loops according to claim 2, wherein step (h5) comprises the steps of:
(i) applying a Laplacian filter to said recurrence graph, and
(ii) determining said plurality of eigenvectors of said Laplacian filtered recurrence graph.

4. The method of generating one or more loops according to claim 2, wherein the eigenvectors of step (h5) are normalized eigenvectors.

5. The method of generating one or more loops according to claim 2, wherein step (h) comprises the steps of:
(h1) generating said one or more loops from one or more of said plurality of stems using said plurality of cut points, and
(h2) using a music hierarchy to modify at least one of said plurality of loops.

6. The method of generating one or more loops according to claim 5, wherein the step of using a music hierarchy to modify at least one of said plurality of loops comprises the step of removing at least one of said plurality of loops from said at least one generated loops.

7. The method of generating one or more loops according to claim 6, wherein said musical hierarchy comprises at least a motif length, a phrase length, a form length, a part length, and a movement length.

8. The method of generating one or more loops according to claim 2, wherein step (h5) comprises the steps of
(i) applying a Laplace filter to said recurrence graph, and
(ii) determining a plurality of eigenvectors of said Laplace filtered recurrence graph.

9. The method of generating one or more loops according to claim 2, wherein said set of eigenvectors is either one of said plurality of determined eigenvectors or all of said plurality of determine eigenvectors.

10. The method of generating one or more loops according to claim 1, wherein step (e) comprises the steps of:
(e1) using at least one of said plurality of stems to estimate beat locations of said audio work, and
(e2) using said beat locations to estimate a tempo of said audio work.
